(19) United States
(12) Patent Application Publication
(10) Pub. No.: US 2015/0053633 A1
(43) Pub. Date: Feb. 26, 2015

(54) ROLLER ASSEMBLY FOR GRAVITY FEED SHELVING AND METHOD OF ASSEMBLY

(71) Applicant: ROLORO LIMITED, Tauranga (NZ)

(72) Inventor: Brian McDonnell, Auckland (NZ)

(21) Appl. No.: 14/383,879

(22) PCT Filed: Feb. 26, 2013
(86) PCT No.: PCT/NZ2013/000020

§ 371 Date: Sep. 8, 2014

(30) Foreign Application Priority Data
Feb. 29, 2012 (NZ) 598494

(51) Int. Cl. A47F 1/04; B65G 13/00; B65G 1/08; A47B 96/02

(52) U.S. Cl. CPC A47F 1/04; A47B 96/025; B65G 13/00; B65G 1/08
USPC 211/151

(57) ABSTRACT

The invention relates to a product supporting roller assembly comprising an elongate spine member and a plurality of rollers, each mounted on the spine member such that the rollers extend outwards on both sides of the spine member. The invention further relates to a product holding unit comprising a plurality of such product supporting roller assemblies. The invention further relates to a method of assembling an axle bearing, which may be used to assembly a product supporting roller assembly, the method comprising positioning a plurality of roller bearings and a roller bearing housing inside a hole, the roller bearings each being connected to a roller bearing holding means and the roller bearings being housed in the roller bearing housing, positioning an axle through the roller bearing housing, and disconnecting the roller bearings from the roller bearing holding means.

### CROSS REFERENCE TO RELATED APPLICATIONS

This application is a national stage entry of International Application No. PCT/NZ2013/000020, filed on 26 Feb. 2013, which claims the benefit of the filing date of NZ Application Serial No. 598494, filed 26 Feb. 2013. The entire contents of the foregoing applications are incorporated by reference herein in their entirety for all purposes.

### FIELD OF INVENTION

The invention relates to roller assemblies for supporting products. More particularly, the invention relates to roller assemblies for shelving units which feed products to the front of the shelving over rollers using gravity.

### BACKGROUND TO THE INVENTION

Many retailers display products to consumers on shelves. It is considered desirable for products on shelves to be displayed neatly to make the products and the retailer more attractive in the eyes of the consumer. Products are moved to the front of shelving to increase the appeal of products, make them more easily accessible to the consumer and provide a neat and tidy shopping experience.

Many stores rely on staff to regularly move products to the front of shelving. However, this is a labour intensive method and risks shelves looking untidy after several products have been taken off a shelf until a member of staff works their way around to re-arrange products on that particular shelf.

Some shelving display units include gravity feed shelving in which, when one product is removed from the front of a shelf, the remaining products automatically move forward into the resulting space under gravity. In its simplest form, this arrangement comprises a sloping shelf with a front barrier to prevent products falling off the shelf.

In more sophisticated gravity feed shelving units, products stand on rollers, an array of which make up the base of the shelving. Rollers assist in moving the products forwards under gravity and, as a result, shelves do not need to be mounted at such a steep angle as gravity feed shelving without rollers.

United States Publication No. 2010/0133214 discloses one example of a gravity feed roller shelving unit. Each shelf comprises at least one line of rollers, or roller unit, arranged in parallel. The rollers are mounted at each end on an inner casing of fixed width. Each shelf is mounted at a small angle of inclination with a riser at the front to prevent products falling off the shelf. Vertical divider elements can be used to divide each shelf into product display areas.

A disadvantage with known gravity feed roller shelving units, such as that disclosed in US 2010/0133214, is the lack of flexibility for arranging different types of products on a shelf, particularly products of different widths or products having a width not complimentary to the width of a roller unit. While a roller unit could be manufactured with any width desired, in practice only a finite number of widths are provided by manufacturers. If products do not match the widths of the roller units then it may be difficult to neatly arrange products on a shelf. Product may need to be spaced out to conform to the arrangement of rollers, which may result in undesirable gaps between products and inefficient use of shelf space. Alternatively, more than one line of products may sit on a single roller unit. If this happens then the roller shelving does not function as intended because one line of product may prevent the rollers turning and allowing the adjacent line of product to move to the front.

Some known roller shelving units are not suitable for displaying products of different shapes and sizes, particularly products with non-planar bases. Such products may be susceptible to toppling because of tipping as they pass over the rollers, or if they contact the non-roller parts of a roller unit.

Roller shelving is often used in chiller cabinets or other refrigerated shelving units. Where goods are kept at a controlled temperature, it is preferable that there is good air flow around the goods. Otherwise, some products may not be stored at the desired temperature and/or energy is used inefficiently. Existing roller shelving arrangements tend to involve much componentry which spans across each shelf, meaning there are few air gaps and air flow around products is reduced.

Many existing roller shelving units use plain roller bearings. Such an arrangement may not be satisfactory where, for example, light products are displayed because the amount of friction may make it difficult for products to slide forwards.

Another problem with many roller shelving units is that the roller mechanisms may be susceptible to clogging when spillage occurs. Such clogging may mean the rollers do not roll easily and the unit has to be cleaned, which is time consuming.

### OBJECT OF THE INVENTION

It is an object of the invention to provide an improved roller assembly and/or improved gravity feed roller shelving. Alternatively, it is an object to provide an improved method of assembling a bearing. Alternatively, it is an object to address at least some of the aforementioned disadvantages associated with the prior art. Alternatively, it is an object of the invention to at least provide the public with a useful choice.

### SUMMARY OF THE INVENTION

According to a first aspect of the invention, there is provided a product supporting roller assembly comprising:
a. an elongate spine member; and
b. a plurality of rollers, each mounted on the spine member such that the rollers extend outwards on both sides of the spine member.

Preferably, each roller is mounted on the spine member by means of a bearing assembly comprising a plurality of roller bearings.

In a preferred embodiment of the invention, the spine member comprises a plurality of holes, each configured to receive one or more rollers.

More preferably, the bearing assembly comprises a roller bearing housing configured to hold the plurality of roller bearings around an inner surface of each hole. In this arrangement, each roller is configured to be mounted in rotating contact with the roller bearings. More preferably, the bearing assembly comprises a needle roller bearing.

In preferred embodiments of the invention, each roller comprises an axle mounted through one of the holes in the spine member and two product supporting rollers mounted on each end of the axle.

In one embodiment of the invention, the roller bearings extend into recesses in the product support rollers such that rotation of the product supporting rollers causes the roller bearings to rotate around the inner surface of the holes.

Preferably, each roller lies in substantially the same plane as an adjacent roller. More preferably, all the rollers lie in the same plane to form a substantially flat rolling surface.

Preferably, each roller is substantially parallel to an adjacent roller. More preferably, all the rollers are parallel to each other.

Preferably, the rollers extend outwards from the spine member at right angles.

In a preferred embodiment of the invention, the rollers extend substantially the same distance outwards on either side of the spine member.

Preferably, the spine member is configured to be mounted on a support portion. The support portion may be adapted to be mounted on a shelf.

Preferably, the spine member and/or the support portion is/are configured to connect to a front portion and/or a back portion. In a preferred embodiment, the front portion comprises, or is connectable to, a barrier means. The barrier means preferably prevents product supported on the roller assembly from rolling off the front of the roller assembly.

More preferably, the front portion, back portion and/or a shelf engagement portion of the product supporting roller assembly comprise one or more track engagement means for engaging to a track. The track engagement means may comprise a male or female engagement portion.

Preferably, the spine member and/or support portion is/are formed from extruded lengths of a material.

In a preferred embodiment, the spine member may comprise first and second rows of holes, the first and second rows of holes having different spacings between holes. The spine member may be changeable between the two sets of holes, for example, by inverting the spine member.

According to a second aspect of the invention, there is provided a product holding unit comprising one or more product supporting roller assemblies according to the first aspect of the invention.

In a preferred embodiment of the invention, the product supporting roller assemblies have a longitudinal axis inclined downwards from the rear of the unit to the front of the unit such that product supported on the roller assemblies travels under gravity towards the front of the unit.

Preferably, the unit comprises more than one roller assembly arranged adjacently to define a shelf surface.

The product holding unit preferably comprises one or more roller assembly receiving means arranged substantially horizontally in a substantially co-planar arrangement with the shelf surface, the roller assemblies being configured to be moveable along the roller assembly receiving means. More preferably, the roller assembly receiving means comprises a track. The track may comprise a male or female engagement portion to couple with the male/female engagement portion of the track engagement means.

Preferably, the holding unit comprises means for fixing the roller assemblies in position on the roller assembly receiving means.

Preferably, the holding unit further comprises one or more barrier means for preventing product rolling off the front end of one or more of the roller assemblies.

In a preferred embodiment, the holding unit further comprises one or more dividers adapted to be mounted between two roller assemblies. In one embodiment of the invention, one or more of the dividers comprise barrier means for preventing product rolling off the front end of one or more of the roller assemblies. More preferably, two adjacent dividers may combine to form a barrier means for preventing product supported between said adjacent dividers from rolling off the front end of one or more of the roller assemblies.

According to a third aspect of the invention, there is provided a method of assembling an axle bearing, the method comprising:
a. positioning a plurality of roller bearings and a roller bearing housing inside a hole, the roller bearings each being connected to a roller bearing holding means and the roller bearings being housed in the roller bearing housing;
b. positioning an axle through the roller bearing housing; and
c. disconnecting the roller bearings from the roller bearing holding means.

In a preferred embodiment of the invention, the roller bearing housing comprises the roller bearing housing means such that the roller bearings are connected to the roller bearing housing.

More preferably, the method further comprises disconnecting the axle from the roller bearing housing, the axle initially being connected to the roller bearing housing.

In an alternative embodiment of the invention, the roller bearing holding means comprises a disconnectable ring member. More preferably, each of the roller bearings is attached at one end to the ring member in spaced apart relationship conforming to slots in the roller bearing housing adapted to receive the roller bearings.

Preferably, the roller bearings comprise needle roller bearings.

Preferably, the roller bearings are easily disconnectable from the roller bearing holding means and/or the axle is easily disconnectable from the roller bearing housing. More preferably, the step(s) of disconnecting two components of the axle bearing comprise snapping or fatiguing the two components apart.

According to a fourth aspect of the invention, there is provided a method of assembling a product supporting roller assembly comprising assembling, according to the method of the third aspect of the invention, a plurality of axle bearings in a spine member.

Preferably, the method further comprises inserting a product supporting roller on each end of each axle.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 is an isometric view illustration of a product supporting roller assembly according to an embodiment of the invention;

FIG. 2 is an isometric view illustration of the spine member of the roller assembly shown in FIG. 1;

FIG. 3 is a cross-sectional view of the support portion of the roller assembly shown in FIG. 1;

FIG. 4 is a front view illustration of one of the rollers of the roller assembly shown in FIG. 1;

FIG. 5 is an isometric view illustration of the front portion of the roller assembly shown in FIG. 1;

FIG. 6 is an isometric view illustration of part of a product holding unit according to another embodiment of the invention;

FIG. 7 is a cross-sectional view illustration of a track extrusion according to an embodiment of the invention;

FIG. 8-14 are isometric view illustrations of steps in a method of assembling a bearing according to an embodiment of the invention;

FIG. 15 is an isometric exploded view illustration of a bearing assembly according to another embodiment of the invention; and

FIG. 16 is an isometric view illustration of a spine member for a product supporting assembly according to an alternative embodiment of the invention.

### DETAILED DESCRIPTION OF PREFERRED EMBODIMENTS OF THE INVENTION

Product Supporting Assembly

One aspect of the invention relates generally to a product supporting assembly. The invention may be particularly used in a product display unit. However, such use is not limiting to the invention. It will be appreciated that the invention may also be used in other situations, for example, where product is being stored but not necessarily on display.

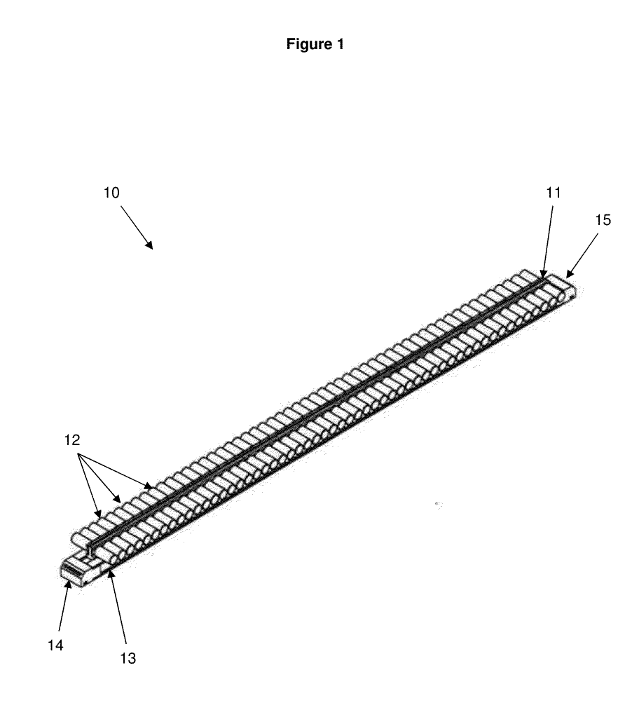

FIG. 1 is an isometric view illustration of a product supporting roller assembly 10 according to an embodiment of the invention. Product supporting roller assembly 10 comprises an elongate spine member 11 and a plurality of rollers 12. Roller assembly 10 may also comprise a support portion 13 upon which spine member 11 is mounted.

Rollers 12 are each mounted on spine member 11 such that the rollers extend outwards from the spine member on both sides. In the preferred embodiment shown, rollers 12 are arranged in aligned pairs and extend outward from the sides of spine member 11 substantially the same distance. Rollers 12 are able to rotate on their longitudinal axes, either in their aligned pairs or independently. A bearing assembly according to the preferred embodiment of the invention, with which the rollers are mounted, will be described in more detail below.

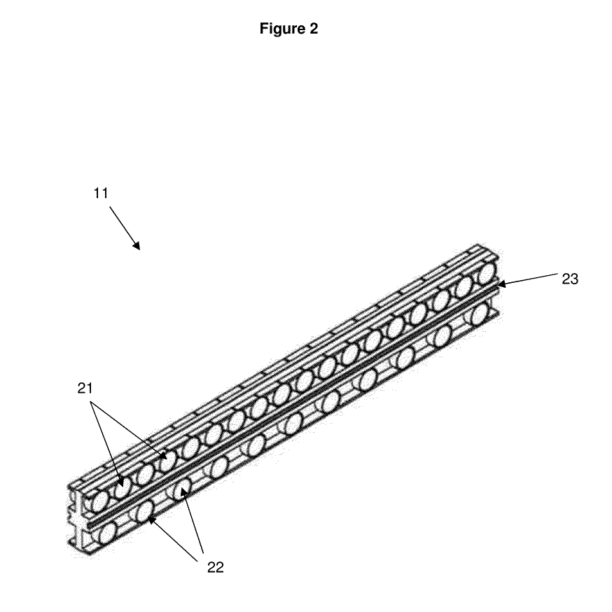

FIG. 2 is an isometric view illustration of spine member 11 shown in FIG. 1. Spine member 11 may be formed from an extruded length of material, for example an injection moulded plastic, but any suitable material may alternatively be used. Spine member 11 comprises a plurality of holes 21 arranged in a row configured to receive rollers 12. The diameter of rollers used determines the appropriate spacing of holes 21.

In the preferred embodiment of the invention shown in FIG. 2, spine member 11 comprises two rows of holes: first set of holes 21 and second set of holes 22. Holes 22 are spaced a different distance apart from each other than holes 21. Where holes are spaced a different distance apart, different sized rollers can be used, or more/less space can be provided between rollers. The different set of holes can be used by simply inverting spine member 11 and mounting the appropriate rollers in the top row of holes. Larger rollers may be preferable where larger products are supported on the roller assembly. Larger spacing between rollers may be preferable where greater air flow around the products is important, for example to keep products at a particular temperature using air conditioning.

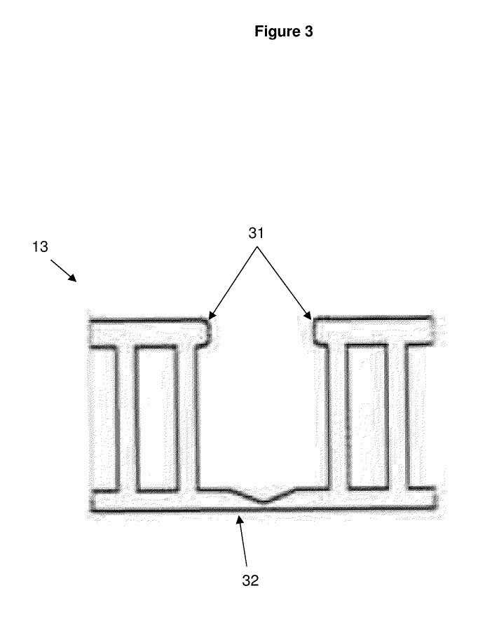

As shown in the embodiment of FIG. 1, spine member 11 may be mounted on a support portion 13. Support portion 13 is preferably formed from an extruded length of a suitable material. FIG. 3 is a cross-sectional view of support portion 13 shown in FIG. 1. Support portion 13 has a broad enough base 32 to prevent spine member 11 from tipping from side-to-side. Spine member 11 may comprise longitudinal slots 23 on its sides that enable it to engage with corresponding protrusions 31 of support portion 13, for example by sliding spine member 11 longitudinally relative to support portion 13. Spine member 11 may comprise more than one modular section and each modular section may, for example be a spine member of the form shown in FIG. 2. A plurality of modular sections of spine may be placed in support portion 13, with their ends abutting each other.

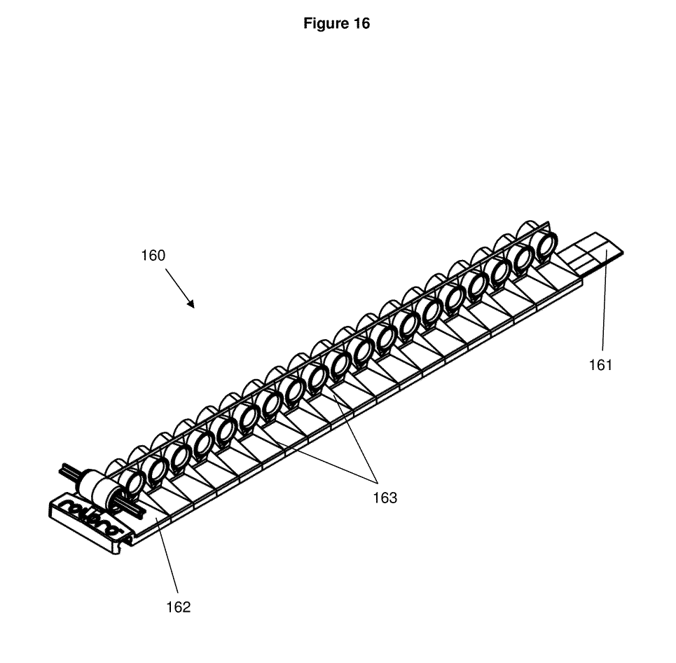

FIG. 16 is an isometric view illustration of a spine member 160 for a product supporting assembly according to an alternative embodiment of the invention. Spine member 160 is able to be longitudinally connected to another spine member by inserting male member 161 into a co-operating female part of the other spine member. Spine member 160 comprises an integrally formed support portion 162 that may incorporate a number of ribs 163 that add strength. The spine member 160 of FIG. 16 may be formed of a plastics material, for example from an injection moulding process. A strengthening member may be provided along the length of the spine member to increase the rigidity of the roller assembly, for example in the form of a stainless steel strip insert into an accommodating slot on the underside of the spine member 160.

In one embodiment of the invention, spine members are provided in 200 mm and 300 mm lengths that are able to be longitudinally connected through any appropriate mechanism, for example the male-female push-fit connection described above in relation to FIG. 16. Through different combinations of these lengths of spine members, roller assemblies having lengths of any multiple of 100 mm over 200 mm long can be formed. This provides flexibility in forming product displays and makes it easy to fit the roller assemblies to existing display units.

Referring again to FIG. 1, rollers 12 have sufficient clearance from the top of support portion 13 such that they are freely able to rotate. Furthermore, the surface defined by the tops of rollers 12 is above the level of the top of spine member 11, thereby allowing free movement of objects along the top of rollers 12 without the objects contacting spine member 11.

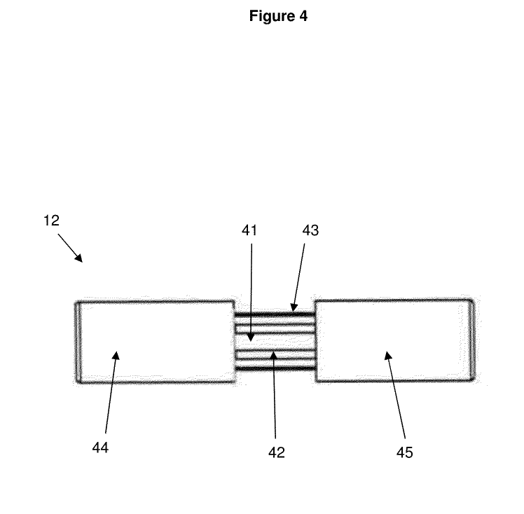

FIG. 4 is a front view illustration of a roller 12 as shown in FIG. 1. Roller 12 comprises an axle 41 which, in use, is positioned through one of holes 12 in spine member 11. On each end of axle 41 are mounted product supporting rollers 44 and 45. In the embodiment shown in the figures, these components are separable parts, but in other embodiments two or more of said components may be integrally formed. The product supporting rollers may be adapted to be removed and replaced with other product supporting rollers of differing length such that the width of the roller assembly can be varied according to need.

Axle 41 is free to rotate inside hole 12. It is desirable to reduce friction caused by the rotational movement of the axle in the hole as far as possible. While any suitable bearing assembly may be used, a preferred embodiment of the invention comprises a bearing assembly in which a plurality of roller bearings 42 are positioned between the inside surface of hole 12 and the outer surface of axle 41. Roller bearings 42 may comprise, for example, needle roller bearings. Roller bearings 42 may be held in place by a roller bearing housing 43 having a cylindrical annular form and being positioned between axle 41 and the inside surface of hole 12. Roller bearing housing 43 may take the form of a cage or race. Such a bearing arrangement may be advantageous compared to a plain bearing arrangement because of the reduction in friction, thus allowing rollers 12 to rotate more freely.

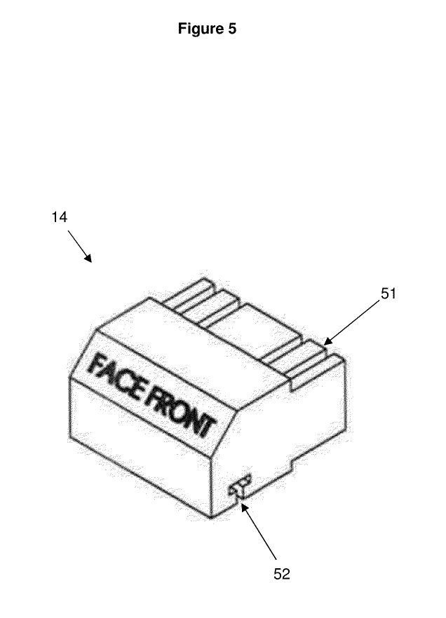

Referring again to FIG. 1, product supporting roller assembly 10 may further comprise front portion 14 and back portion 15. FIG. 5 is an isometric view illustration of front portion 14 as shown in FIG. 1. Front portion 14 comprises means 51 for connecting to support portion 13 and means 52 for mounting roller assembly 10 on a suitable supporting unit, as will be described in more detail below. Back portion 15 has the same or similar form to front portion 14. Front portion 14 may be formed to provide an aesthetically appealing look to roller assembly 10, particularly where used in a customer display context.

In use, a plurality of products is positioned on the upper surface of product supporting roller assembly 10, said upper surface being defined by the tops of rollers 12. Products are preferably of substantially comparable width to the width of roller assembly 10 and are thus arranged in a row longitudinally along the top of roller assembly 10. In a preferred embodiment of the invention, roller assembly 10 is inclined such that its longitudinal axis tilts downwards towards the front. In this way, when one product is removed from the front end of the roller assembly, the remaining products move forwards under gravity. As a result, product is always stored or displayed at the front end of the roller assembly.

Front portion 14 preferably comprises, or is adapted to receive, a barrier means which prevents product stored on the roller assembly from rolling off the front. Suitable size and form of barrier means is dependent on the size and mass of product supported on roller assembly 10.

Product Holding Unit

In a further aspect of the invention, there is provided a product holding unit that comprises one or more product supporting roller assemblies, such as those discussed above. Product holding unit may comprise, for example, a display cabinet for use on a shop floor, or a product storage assembly. Typically, the product holding unit will comprise a plurality of roller assemblies arranged adjacently to define a shelf surface. The product holding unit may comprise an array of shelves of roller assemblies.

As discussed above, the roller assemblies are preferably mounted on the product holding unit such that the longitudinal axis of each roller assembly is inclined downwards from the rear of the unit to its front, and adjacent roller assemblies are preferably inclined in the same plane to form one or more planar shelf surfaces for supporting products thereon. In this way, products are moved forward under gravity when product is removed from the front of a roller assembly.

The product holding unit is adapted to support the one or more roller assemblies in the desired arrangement. In one embodiment, the product holding unit comprises an assembly of one or more shelves, the shelves being themselves inclined downwards with the roller assemblies being mounted on the shelves. In another embodiment, the product holding unit comprises a framework on which the roller assemblies are mounted.

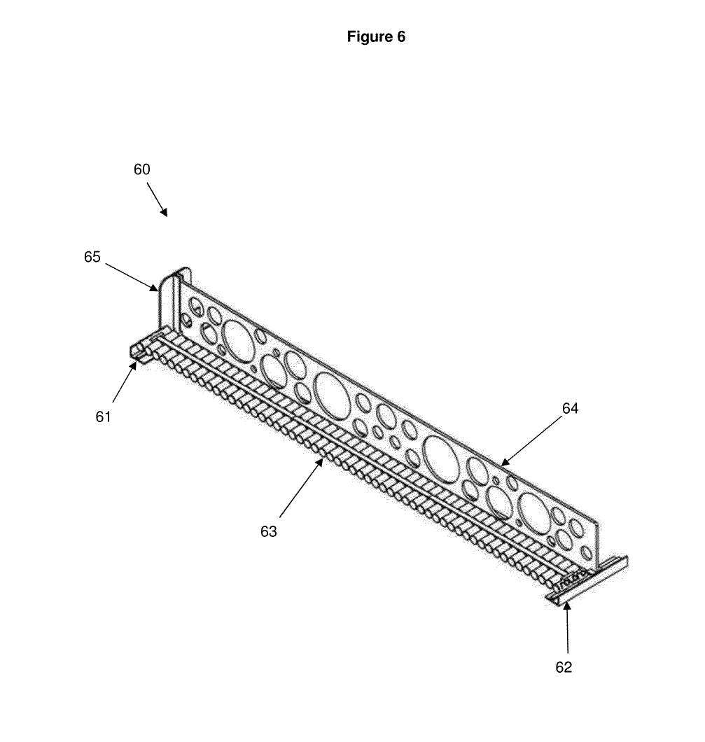

FIG. 6 is an isometric view illustration of part of a product holding unit 63 according to another embodiment of the invention. While much of the product holding unit is not illustrated in FIG. 6, roller assembly 63 is shown mounted on roller assembly receiving means in the form of front track 61 and back track 62. Tracks 61 and 62 are preferably extruded lengths of material and only one lateral section of each track is shown in FIG. 6. Tracks 61 and 62 are arranged substantially horizontally on the product holding unit and may rest or be attached directly on a shelf or comprise part of the framework of the product holding unit, thereby defining a shelf surface.

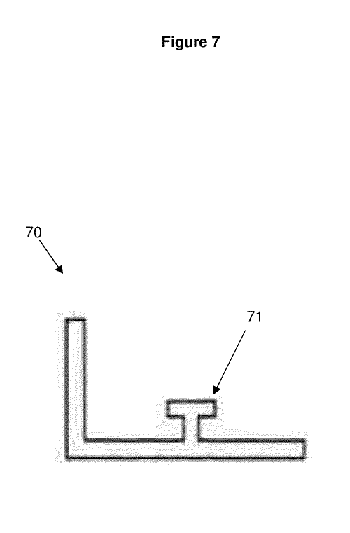

FIG. 7 is a cross-sectional view illustration of a track extrusion 70 according to an embodiment of the invention, for example tracks 61 and 62 as shown in FIG. 6. Track extrusion 70 comprises means 71 for receiving a roller assembly, such as roller assembly 10 shown in FIG. 1. In the embodiment shown, means 71 comprises a longitudinally extending projection which is configured to fit inside elongate recess 52 of front portion 14 shown in FIG. 5. In alternative embodiments, different ways of mounting the roller assembly on tracks may be provided, for example other arrangements of male/female engagement portions.

In the embodiment shown in FIG. 6, roller assembly 63 is moveable horizontally along tracks 61 and 62, thereby enabling the position of roller assembly 63 to be varied along a shelf. More than one roller assembly can be mounted on tracks 61 and 62 and their positions can be altered according to what is desired. In one embodiment, the roller assemblies are able to be fixed in position along tracks 61, 62 by any appropriate means.

A product holding unit according to the invention may further comprise one or more dividers, such as divider 64 shown in FIG. 6. Divider 64 comprises an elongate vertical portion adapted to be mounted between two roller assemblies. Divider 64 segregates product stored on one roller assembly from product stored on an adjacent roller assembly, ensuring product is kept in good alignment and one item cannot move laterally such that it straddles more than one roller assembly, which could affect the ability of either assembly to move product forwards under gravity. In the embodiment shown in FIG. 6, divider 64 is adapted to be mounted on tracks 61, 62 and slideable along the tracks so that the position of the divider can be varied as required.

In the embodiment shown in FIG. 6, divider 64 comprises bather portion 65 which may take the illustrated form of a vertical portion aligned transversely to the longitudinal axis of the divider. Barrier portion 65 prevents product rolling off the front of roller assembly 63. A further divider may be positioned on the other side of roller assembly 63 from divider 64. If the further divider also comprises a barrier portion similar to barrier portion 65 then the two barrier portions in combination may be more effective in preventing product falling off the roller assembly. Such an arrangement is an alternative to the aforementioned arrangement in which the barrier means is formed by a vertical member mounted on the front end of the roller assembly. The arrangement in which the dividers comprise barrier portions may be desirable because product supported on roller assembly 63 may be more easily visible, enabling a label or the like to be easily read.

In the preferred embodiments of the invention described above, the roller assemblies comprise a plurality of rollers lying in the same plane and substantially parallel to each other. This provides a planar, linear rolling surface along which products can slide. In alternative embodiments, one or more of the roller assemblies may comprise one or more curves in the arrangement of rollers. In one embodiment, the line of rollers is curved laterally such that products can slide in a curve around a corner. To ensure a smooth gradual curve, each roller is almost but not quite parallel to the adjacent roller. In this embodiment, dividers having curves corresponding to the curve of the line of rollers are preferably used to assist in maintaining the products on the rollers. In another embodiment, the line of rollers includes slight changes in gradient. Again, each roller is only slightly offset from the adjacent roller to ensure a smooth sliding surface. A further embodiment may combine both of the aforementioned embodiments.

### Advantages of Embodiments of the Invention

The embodiments of the invention described above provide a number of advantages over known gravity feed roller assemblies, some of which are noted below:

The modularity of the roller assemblies and dividers provides greater flexibility to support a variety of product types without the need for specifically tailored units.

Products of different widths can easily be stored using the same roller assemblies. Roller assemblies may be spaced apart as is desirable according to the width of the products to be supported on each roller assembly.

Dividers can also be positioned as desired according to the product widths.

The width of an individual roller assembly can be varied by simple replacement of the rollers with rollers of differing length. This avoids the need to use entirely different roller mountings, as with known systems.

The central spine arrangement means there is more space between roller assemblies, compared to existing assemblies with mounts on either side of each roller. The increased space means air can flow more freely around the product holding unit and the products, meaning enhanced ventilation, and more efficient and more uniform control of air temperature throughout the unit.

The use of roller bearings reduces friction in each roller compared to a similar arrangement with a plain bearing. This improves forward movement of product on the roller assembly and means even relatively light products can be displayed/stored using the invention.

Method of Assembling Bearing

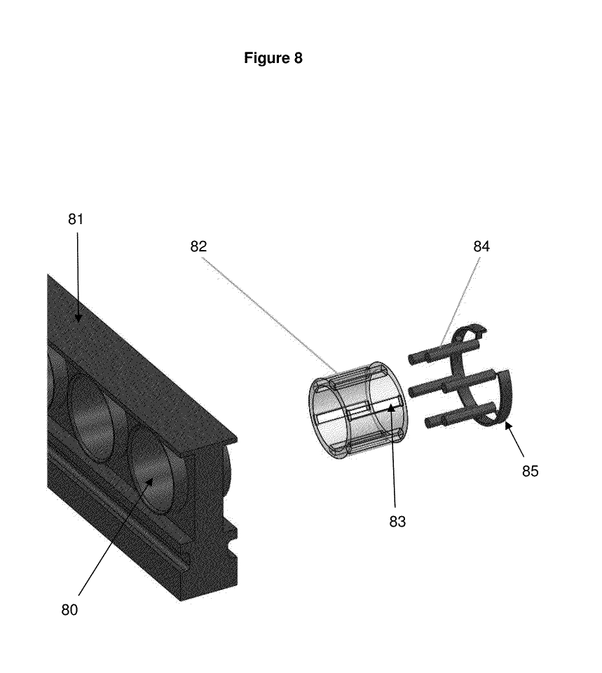

As already noted, it is desirable to reduce friction in a roller assembly as far as possible. One example of a bearing assembly has already been discussed in relation to FIG. 4. There will now be described, with reference to FIGS. 8 to 14, a method of assembling an axle bearing according to an embodiment of the invention.

FIG. 8 illustrates some components of an axle bearing prior to assembly. A hole 80 is provided in an apparatus in which the axle bearing needs to be assembled. In the embodiment of the invention described herein, the apparatus is a spine member 81 for a roller assembly, such as has been described hereinabove. A roller bearing housing 82 is also provided, which may be similar to roller bearing housing 43 as was described in relation to FIG. 4. Roller bearing housing 82 takes the form of a roller bearing cage or race and is annularly cylindrical and comprises a plurality of spaced apart slots 83 in which roller bearings can be received. When positioned inside slots 83, the roller bearings are able to rotate about their longitudinal axes but are held in position by roller bearing housing 82.

Further provided are a plurality of roller bearings, such as needle roller bearings 84, which are attached to a roller bearing holding means. In the preferred form of the embodiment shown in FIG. 8, roller bearing holding means comprises ring member 85, to which one end of each of roller bearings 84 is attached. The roller bearings are attached to the ring member in a manner that makes the ring member disconnectable from the roller bearings with limited force, as will be described further below. Roller bearings 84 are attached to ring member 85 in spaced apart relationship to conform to the position of slots 83 in roller bearing housing 82.

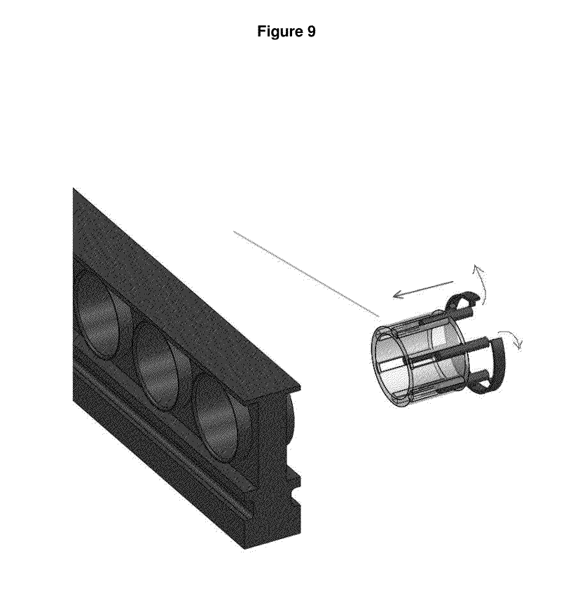

Referring now to FIG. 9, roller bearings 84 are each inserted into one of slots 83 in roller bearing housing 82.

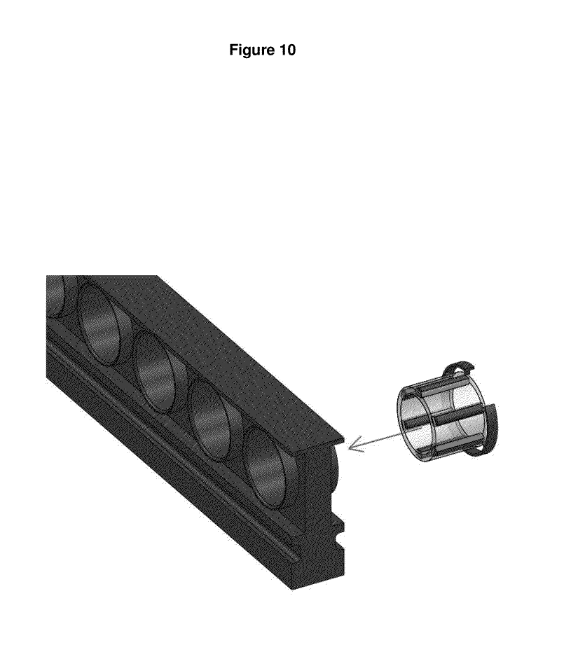

Referring to FIG. 10, the next step is for roller bearing housing 82, together with roller bearings 84, to be inserted into hole 80.

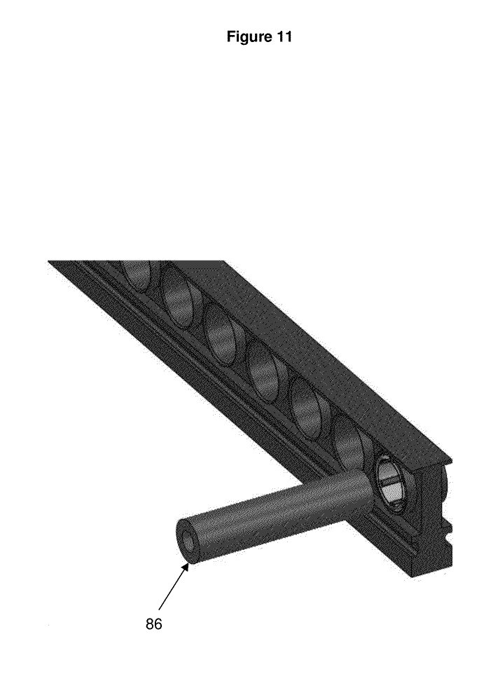

Next, with reference to FIG. 11, axle 86 is inserted in to the roller bearing housing, once the bearing housing is positioned inside hole 80. Once axle 86 is in position then ring member 85 is disconnected from the ends of roller bearings 84. In a preferred embodiment, ring member 85 is connected to roller bearings 84 in such a way that it can be disconnected by hand, for example by small joining strips that can be easily snapped or fatigued apart. Once ring member 85 is disconnected, roller bearings 84 are free to rotate on their axes.

It can be seen that this method of assembling an axle bearing is advantageous in that the roller bearings are easy to insert into the roller bearing housing because the ring member holds them in a spaced apart relationship conforming to the slots in the housing. Furthermore, holding the roller bearings in position until the axle is positioned prevents the roller bearings falling out of the housing while the bearing is still being assembled.

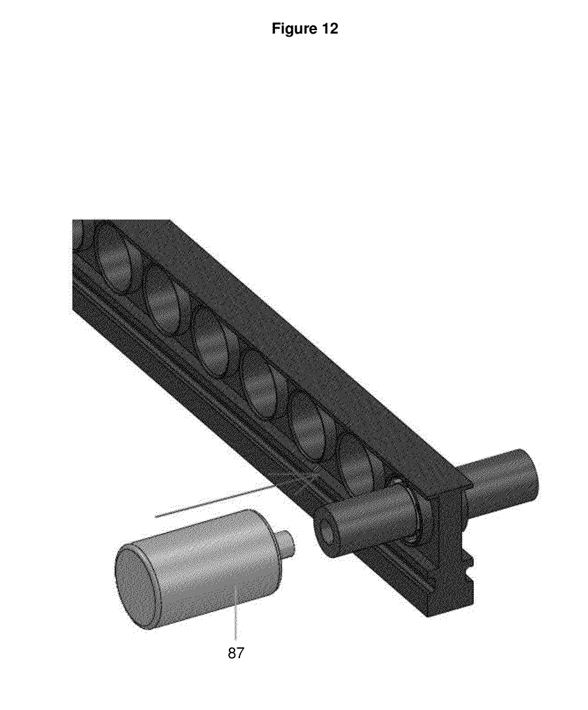

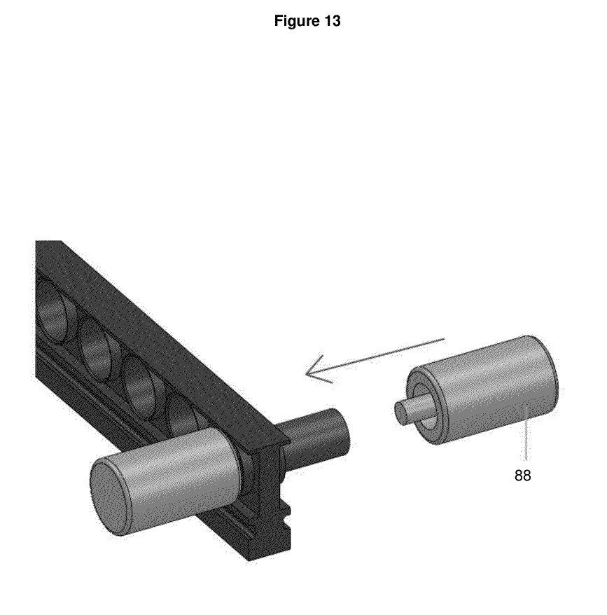

FIGS. 12 and 13 illustrate the next steps in the process when applied to assembling a product supporting roller assembly, as has been described above. That is, product supporting rollers 87 and 88 are mounted on each end of axle 86. In the embodiment shown, product supporting rollers 87, 88 slide onto the ends of the axle 86 and are held on the axle by friction.

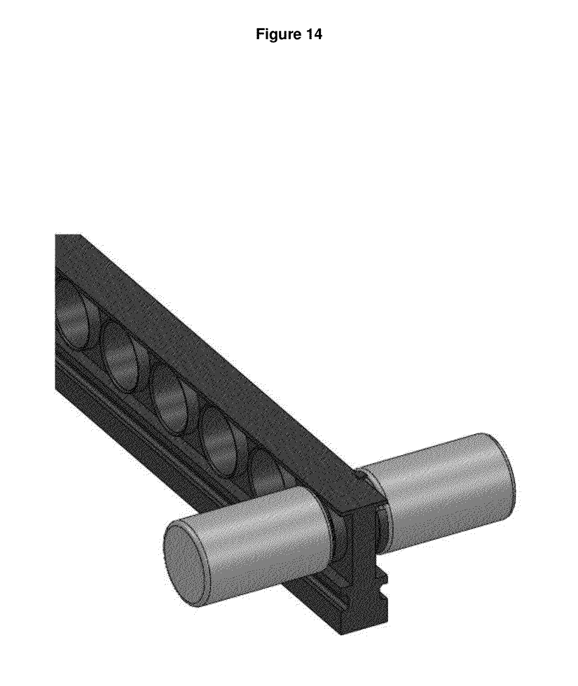

FIG. 14 illustrates one roller mounted on a spine member according to an embodiment of the invention. The method of explained above in relation to FIG. 8 to 13 is repeated to mount further rollers on the spine member.

Alternative Bearing Assembly

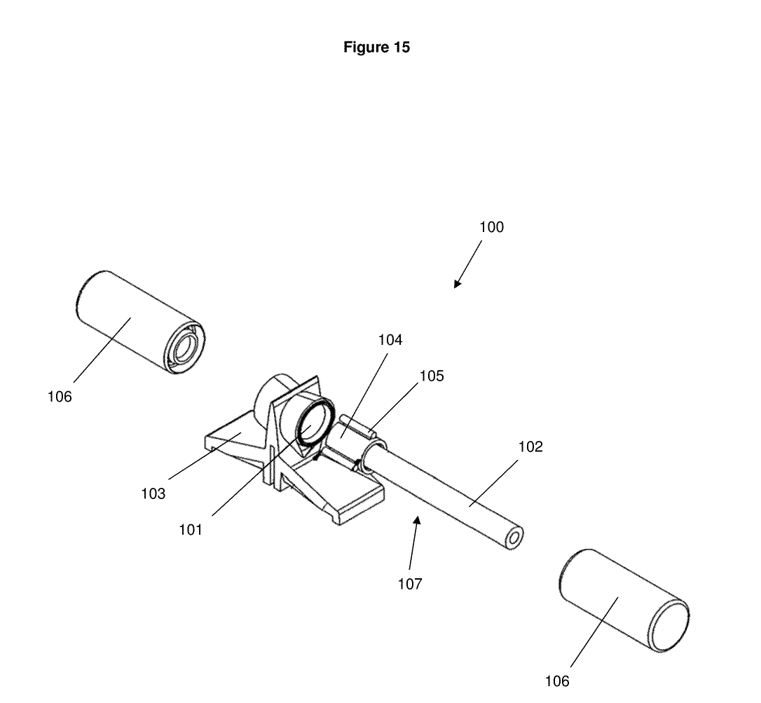

FIG. 15 is an isometric exploded view illustration of a bearing assembly 100 according to another embodiment of the invention. Bearing assembly 100 enables an axle 102 to turn in hole 101. In the embodiment of FIG. 15, hole 101 is defined by part of a spine member 103 of a product support assembly similar to that described above. It will be appreciated that only a small longitudinal section (including only one bearing hole 101) of the spine member 103 is shown for illustrative purposes.

In use, axle 102 is free to rotate inside hole 101. A plurality of roller bearings 105 held in place by a roller bearing housing 104 are positioned between the axle 102 and the inside surface of hole 101 to reduce friction when the axle rotates. Product supporting rollers 106 may be mounted on the ends of the axle 102 for the bearing assembly to be used in a product supporting assembly.

In one embodiment of the invention, the bearing assembly illustrated in FIG. 15 and described above may be assembled in the following manner. Axle 102, roller bearing housing 104 and roller bearings 105 may be provided as a single, integrally formed member 107, such as is shown in FIG. 15, with the components being connected by linkages that be readily snapped off or fatigued apart. For example, the integrally formed member 107 may be formed from a plastics material with narrow strips of plastic connecting the roller bearings 105 to the roller bearing housing 104 and the roller bearing housing 104 to the axle 102.

When assembling the bearing assembly 100, the end of the integrally formed member 107 with the roller bearings 105 and roller bearing housing 104 is inserted into hole 101. In doing so, the roller bearings 105 are pushed inwards, separating them from roller bearing housing 104. The axle 102 is then pushed forwards into hole 101, causing the snap offs to fail to separate the axle from the roller bearing housing 104.

The methods of assembling an axle bearing described above in relation to FIGS. 8 to 14 and in relation to FIG. 15 both involve roller bearings that are initially connected to a roller bearing holding means in order to hold the roller bearings in place during the assembly process. In the embodiment of FIGS. 8 to 14, the roller bearing holding means comprises disconnectable ring member 85 while in the embodiment of FIG. 15, the roller bearing holding means comprises the roller bearing housing 104 itself.

The embodiment of FIG. 15 may provide a cost effective way to manufacture and assemble a bearing assembly according to the invention. Advantageously, the integrally formed member 107 in the form shown in FIG. 15 can be formed by injection moulding, which is relatively cheap compared to other techniques. The components of the bearing can then be assembled quickly using the snap off or disconnection method described. In the embodiment of FIG. 15, no parts are disposed off in the assembly of the bearing, while in the embodiments of FIGS. 8 to 14, the disconnectable ring member is taken off and thrown away.

Referring to the numbering of components in FIG. 15, in some embodiments the inner ends of product supporting rollers 106 which connect to axle 102 may include a plurality of recesses configured to receive the ends of the roller bearings 105. This causes the roller bearings 105 to rotate around the inner surface of hole 101 as the product supporting rollers 106, which may be advantageous in enabling the bearing to rotate with little friction.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A product supporting roller assembly comprising:
an elongate spine member; and
a plurality of rollers, each mounted on the spine member such that the rollers extend outwards on both sides of the spine member.

2. A product supporting roller assembly as claimed in claim 1, wherein the spine member comprises a plurality of holes, each configured to receive one or more rollers.

3. A product supporting roller assembly as claimed in claim 1 or 2, wherein each roller is mounted on the spine member by means of a bearing assembly comprising a plurality of roller bearings.

4. A product supporting roller assembly as claimed in claim 3, wherein the bearing assembly comprises a roller bearing housing configured to hold the plurality of roller bearings around an inner surface of each hole.

5. A product supporting roller assembly as claimed in claim 4, wherein each roller is configured to be mounted in rotating contact with the roller bearings.

6. A product supporting roller assembly as claimed in any one of claims 2-5, wherein each roller comprises an axle mounted through one of the holes in the spine member and two product supporting rollers mounted on each end of the axle.

7. A product supporting roller assembly as claimed in claim 6, wherein the roller bearings extend into recesses in the product support rollers such that rotation of the product supporting rollers causes the roller bearings to rotate around the inner surface of the holes.

8. A product supporting roller assembly as claimed in any one of the preceding claims, wherein each roller lies in substantially the same plane as an adjacent roller.

9. A product supporting roller assembly as claimed in claim 8, wherein all the rollers lie in the same plane to form a substantially flat rolling surface.

10. A product supporting roller assembly as claimed in any one of the preceding claims, wherein each roller is substantially parallel to an adjacent roller.

11. A product supporting roller assembly as claimed in claim 10, wherein all the rollers are

12. A product supporting roller assembly as claimed in any one of the preceding claims, wherein the rollers extend outwards from the spine member at right angles.

13. A product supporting roller assembly as claimed in any one of the preceding claims, wherein the rollers extend substantially the same distance outwards on either side of the spine member.

14. A product supporting roller assembly as claimed in any one of the preceding claims, wherein the spine member is configured to be mounted on a support portion, the support portion being adapted to be mounted on a shelf.

15. A product supporting roller assembly as claimed in any one of the preceding claims, wherein the spine member and/or the support portion is/are configured to connect to a front portion and/or a back portion.

16. A product supporting roller assembly as claimed in claim 15, wherein the front portion comprises, or is connectable to, a barrier means, the barrier means acting to prevent product supported on the roller assembly from rolling off the front of the roller assembly.

17. A product supporting roller assembly as claimed in claim 15 or 16, wherein the front portion, back portion and/or a shelf engagement portion of the product supporting roller assembly comprise one or more track engagement means for engaging to a track.

18. A product supporting roller assembly as claimed in any one of the preceding claims, wherein the spine member is formed from an extruded length of a material.

19. A product supporting roller assembly as claimed in any one of the preceding claims, wherein the spine member comprises first and second rows of holes, the first and second rows of holes having different spacings between holes.

20. A product holding unit comprising one or more product supporting roller assemblies according to any one of claims 1-19.

21. A product holding unit as claimed in claim 20, wherein the product supporting roller assemblies have a longitudinal axis inclined downwards from the rear of the unit to the front of the unit such that product supported on the roller assemblies travels under gravity towards the front of the unit.

22. A product holding unit as claimed in claim 20 or 21, wherein the unit comprises more than one roller assembly arranged adjacently to define a shelf surface.

23. A product holding unit as claimed in claim 22, wherein the product holding unit comprises one or more roller assembly receiving means arranged substantially horizontally in a substantially co-planar arrangement with the shelf surface, the roller assemblies being configured to be moveable along the roller assembly receiving means.

24. A product holding unit as claimed in claim 23, wherein the roller assembly receiving means comprises a track, the track comprising an engagement portion to couple with an engagement portion of the track engagement means.

25. A product holding unit as claimed in claim 23 or 24, wherein the holding unit comprises means for fixing the roller assemblies in position on the roller assembly receiving means.

26. A product holding unit as claimed in any one of claims 20-25, wherein the holding unit further comprises one or more barrier means for preventing product rolling off the front end of one or more of the roller assemblies.

27. A product holding unit as claimed in any one of claims 20-26, wherein the holding unit further comprises one or more dividers adapted to be mounted between two roller assemblies.

28. A product holding unit as claimed in claim 27, wherein one or more of the dividers comprise barrier means for preventing product rolling off the front end of one or more of the roller assemblies.

29. A product holding unit as claimed in claim 28, wherein two adjacent dividers combine to form a barrier means for preventing product supported between said adjacent dividers from rolling off the front end of one or more of the roller assemblies.

30. A method of assembling an axle bearing, the method comprising:
positioning a plurality of roller bearings and a roller bearing housing inside a hole, the roller bearings each being connected to a roller bearing holding means and the roller bearings being housed in the roller bearing housing;
positioning an axle through the roller bearing housing; and
disconnecting the roller bearings from the roller bearing holding means.

31. A method as claimed in claim 30, wherein the roller bearing housing comprises the roller bearing holding means such that the roller bearings are connected to the roller bearing housing.

32. A method as claimed in claim 30 or 31, wherein the method further comprises disconnecting the axle from the roller bearing housing, the axle initially being connected to the roller bearing housing.

33. A method as claimed in claim 30, wherein the roller bearing holding means comprises a disconnectable ring member.

34. A method as claimed in claim 33, wherein each of the roller bearings is attached at one end to the ring member in spaced apart relationship conforming to slots in the roller bearing housing adapted to receive the roller bearings.

35. A method as claimed in any one of claims 30-34, wherein the roller bearings are easily disconnectable from the roller bearing holding means and/or the axle is easily disconnectable from the roller bearing housing.

36. A method as claimed in claim 35, wherein the step(s) of disconnecting two components of the axle bearing comprise snapping or fatiguing the two components apart.

37. A method of assembling a product supporting roller assembly comprising assembling, according to the method of any one of claims 30-36, a plurality of axle bearings in a spine member.

38. A method as claimed in claim 37, wherein the method further comprises inserting a product supporting roller on each end of each axle.

39. A product supporting roller assembly substantially as hereinbefore described with reference to any one of the embodiments shown in the figures.

40. A product holding unit substantially as hereinbefore described with reference to any one of the embodiments shown in the figures.

41. A method of assembling an axle bearing substantially as hereinbefore described with reference to any one of the embodiments shown in the figures.

42. A method of assembling a product supporting roller assembly substantially as hereinbefore described with reference to any one of the embodiments shown in the figures.
